(19) United States
(12) Patent Application Publication
(10) Pub. No.: US 2015/0070890 A1
(43) Pub. Date: Mar. 12, 2015

(54) LIGHT SOURCE BOARD UNIT

(71) Applicant: SHARP KABUSHIKI KAISHA, Osaka-shi, Osaka (JP)

(72) Inventors: Masanobu Okano, Osaka-shi (JP); Ken Sumitani, Osaka-shi (JP)

(73) Assignee: SHARP KABUSHIKI KAISHA, Osaka-shi, Osaka (JP)

(21) Appl. No.: 14/391,177

(22) PCT Filed: Apr. 10, 2013
(86) PCT No.: PCT/JP2013/060775

§ 371 Date: Oct. 8, 2014

(30) Foreign Application Priority Data
Apr. 12, 2012 (JP) 2012-091249

(51) Int. Cl. F21V 19/00; F21K 99/00

(52) U.S. Cl. CPC F21V 19/002; F21K 9/30; F21K 9/56
USPC 362/235

(57) ABSTRACT

Provided is an light source board unit enabling improved freedom in the shape and material for a resin part, suppression of increased costs, and compatibility of optical characteristics and physical characteristics. This light source substrate unit (1) is provided with a plurality of LED chips (2) and a base material (10) having a plurality of recesses (10a) in which the LED chips are mounted. The base material includes a first resin part (11) fabricated by injecting a first resin and a second resin part (12) fabricated by injecting a second resin. The first resin part and the second resin part have mutually different optical characteristics, and at least a portion of the inner surface of the recesses is formed by the second resin part.

### TECHNICAL FIELD

The present invention relates to a light source board unit, more particularly, to a light source board unit that includes a plurality of light emitting devices and a base member on which the plurality of light emitting devices are mounted.

### BACKGROUND ART

In recent years, a light source board unit including a light emitting diode (LED) as a light source, and a light source module using this light source board unit are spreading their uses. Conventionally, a cold cathode fluorescent lamp is the most common as a light source of a backlight apparatus for a liquid crystal display apparatus, but the cold cathode fluorescent lamp is rapidly replaced with an LED device (light emitting device). Because of this replacement, it becomes possible to abolish use of mercury that has a high environmental burden, reduce power consumption, and achieve longevity of the backlight apparatus.

As such a light source board unit, a light source board unit, in which an LED device (light emitting device) including an LED chip is directly mounted on a board by means of a method called COB (Chip On Board) mounting, and a light source board unit, in which an LED device including an LED package incorporating an LED chip is mounted on a board, are known.

In the meantime, in the present specification and claims, a light emitting device is a concept that comprehends both a light emitting chip itself (LED chip and the like) and a package (LED package and the like) that incorporates the light emitting chip.

FIG. 9 and FIG. 10 are views that show schematically an example of a structure of a conventional backlight apparatus that includes a light source board unit in which an LED device including an LED chip is mounted directly on a board. FIG. 11 and FIG. 12 are views that show a structure of the light source board unit of the conventional backlight apparatus shown in FIG. 9. A backlight apparatus 1001 shines light onto a liquid crystal display panel (not shown). As shown in FIG. 9, the backlight apparatus 1001 comprises: a light source board unit 1002: a light guide plate 1003 into which light from the light source board unit 1002 is input and which outputs the light to the liquid crystal panel side (upper side of FIG. 9); a reflection sheet 1004 that is disposed to oppose a rear side (lower side of FIG. 9) of the light guide plate 1003; a diffusion sheet 1005 that is disposed on the light guide plate 1003; and a housing 1006 that houses the light source board unit 1002 and the light guide plate 1003 and the like.

The light guide plate 1003 has: a light output surface 1003a that is the largest surface and disposed to oppose the liquid crystal display side (upper side of FIG. 9); and a light input surface 1003b (see FIG. 10) which is disposed to intersect the light output surface 1003a and into which the light from the light source board unit 1002 is input. The light output from the light source board unit 1002 enters the light input surface 1003b of the light guide plate 1003. The light entering the light guide plate 1003 is mixed in the light guide plate 1003 to be evened and output as surface light from the light output surface 1003a. The reflection sheet 1004 has a function that reflects light, which leaks from the light guide plate 1003 via a surface (lower surface of FIG. 9) opposite to the light output surface 1003a, to return the light into the light guide plate 1003. According to this, it is possible to improve light use efficiency. The diffusion sheet 1005 has a function that evens the light output from the light output surface 1003a of the light guide plate 1003 to alleviate brightness unevenness.

As shown in FIG. 11 and FIG. 12, the light source board unit 1002 includes a plurality of LED chips 1010 and a base member 1020 on which the LED chips 1010 are mounted. The base member 1020 includes a resin portion 1021 having a substantially flat plate shape and a wiring layer 1022 that is integrally formed with the resin portion 1021. The resin portion 1021 is provided with a plurality of recess portions 1021a that house the LED chips 1010. An inner surface of the recess portion 1021a has a bottom surface 1021b that is a mounting surface on which the LED chip 1010 is mounted and an inner side surface 1021c that encloses the LED chip 1010. The resin portion 1021 is formed by injection-molding a resin. In the meantime, in FIG. 11 and FIG. 12, for the sake of easy understanding of the structure of the base member 1020, hatching is applied to the resin portion 1021 and the wiring layer 1022. However, hatching is not applied to the surface of the resin portion 1021 on which the LED chip 1010 is mounted.

The LED chip 1010 is mounted on the bottom surface 1021b of the recess portion 1021a and electrically connected to the adjacent LED chip 1010 and the wiring layer 1022. Of the plurality of wiring layers 1022 disposed on the base member 1020, the leftmost wiring layer 1022 in FIG. 11 and FIG. 12 is electrically connected to an electrode terminal (not shown) of a connector member 1012. A wire harness (not shown) for supplying electric power to the LED chip 1010 is connected to the connector member 1012.

Besides, a seal resin 1013, which seals the LED chip 1010 and the bonding wire 1011, is disposed in the recess portion 1021a.

In this backlight apparatus 1001, the resin portion 1021 of the base member 1020 is formed by means of injection molding; accordingly, it is possible to improve the degree of shape freedom of the resin portion 1021 and the degree of material freedom of the resin portion 1021.

In the meantime, for example, a patent document 1 discloses an illumination apparatus in which an LED device (light emitting device) including an LED chip is directly mounted on a board. In this patent document 1, an apparatus board (board) includes a metal-based board (also called a metal base board). The metal base board is obtained by laminating a resin layer and a wiring layer on a surface of a metal plate that is disposed as a base member.

### CITATION LIST

### Patent Literature

PLT1: JP-A-2008-277561

### SUMMARY OF INVENTION

### Technical Problem

In the meantime, the resin used for the resin portion 1021 of the light source board unit 1002 needs to have both good optical properties an good physical properties. For example, it is preferable that the resin used for the resin portion 1021 has a high light reflectance (one of the optical properties). According to this structure, in the case where part of the light output from the light source board unit 1002 is reflected by the light input surface 1003b of the light guide plate 1003, it is possible to reflect the reflected light by means of the resin portion 1021 to input the light into the light guide plate 1003. In this way, it is possible to improve the light use efficiency. Besides, to alleviate a change in color tone of the light reflected at the resin portion 1021, the color tone (one of the optical properties) of the resin portion 1021 also is important. Besides, as the resin used for the resin portion 1021, a resin, which is good in physical properties such as rigidity, elasticity, impact resistance, wear resistance, thermal stability, linear expansion coefficient and the like, is selected.

However, it is generally hard to meet both the good optical properties and the good physical properties with a high level. Or, even if there is a resin that meets the optical properties and physical properties with a high level, if a usable raw material is limited, there is a possibility that the cost becomes expensive.

In the meantime, in the present specification and claims, the optical property is a concept that comprehends total light reflectance, specular reflectance, diffuse reflectance, wavelength distribution of reflectance, color tone, light distribution characteristics of diffusion reflection, a relationship between a light incident angle and light distribution characteristics of diffusion reflection and the like. Besides, the physical property is a concept that comprehends rigidity, elasticity, impact resistance, wear resistance, thermal stability, linear expansion coefficient and the like.

Besides, as in the patent document 1, in the case where a metal plate is used as a base member and a resin layer and a wiring layer are laminated on a surface of the base member, there is a problem that it is hard to improve the degree of shape freedom of the resin layer (resin portion) and the degree of material (polymer) freedom of the resin.

This invention has been made to solve the above problems, and it is an object of this invention to provide a light source board unit that is able to improve the degree of freedom of shape and material of a resin portion, alleviate the cost becoming expensive, and allow the optical properties and the physical properties to be compatible with each other.

### Solution to Problem

To achieve the above object, a light source board unit according to this invention comprises: a plurality of light emitting devices, and a base member that has a plurality of recess portions in which the light emitting devices are mounted, wherein the base member includes a first resin portion obtained by injection-molding a first resin and a second resin portion obtained by injection-molding a second resin, the first resin portion and the second resin portion have optical properties different from each other, and at least part of an inner surface of the recess portion is formed of the second resin portion.

In this light source board unit, as described above, the base member includes the first resin portion obtained by injection-molding the first resin and the second resin portion obtained by injection-molding the second resin, and the first resin portion and the second resin portion have the optical properties different from each other. According to this, for example, as the first resin, it is possible to use a resin that has good physical properties, and as the second resin, it is possible to use a resin that has good optical properties. Because of this, it is possible to obtain the base member that has both the good optical properties and the good physical properties. Or, even if the second resin has the good optical properties and the good physical properties, in a case where the second resin is expensive, it is possible to use the first resin for a portion where the optical properties are not important. In this way, it is possible to reduce a use amount of the second resin and alleviate the cost of the base member becoming expensive.

Besides, by forming at least part of the inner surface of the recess portion by means of the second resin portion, it is possible to make the optical properties of at least the part of the inner surface of the recess portion different from the optical properties of the other parts.

Besides, by forming the first resin portion and the second resin portion by means of injection molding, compared with a resin layer (resin portion) of a metal base board, for example, it is possible to improve the degree of freedom of shape and material (polymer) of the resin portion (the first resin portion and the second resin portion).

In the above light source board unit, preferably, the second resin portion has total light reflectance higher than the first resin portion. According to this structure, it is possible to raise the total light reflectance of at least part of the inner surface of the recess portion. In this way, it is possible to reflect light, which is output from the light source board unit and reflected to return, by means of at least the part of the inner surface of the recess portion with the high total light reflectance. Because of this, it is possible to improve the light use efficiency.

In the meantime, the total light reflectance is a sum of a specular reflectance and a diffuse reflectance.

In the above light source board unit, preferably, the second resin portion has a whitish color. According to this structure, color tone of the light reflected by the second resin portion becomes unlikely to change.

In the above light source board unit, preferably, the light emitting device emits bluish light; the second resin portion contains a fluorescent material that converts the bluish light into yellowish light: and the bluish light from the light emitting device and the yellowish light from the second resin portion are mixed with each other to obtain whitish light. According to this structure, it is possible to convert the bluish light into the yellowish light by means of the second resin portion; accordingly, it is unnecessary to additionally dispose a member that contains a fluorescent material which converts the bluish light into the yellowish light.

In the above light source board unit, preferably, the first resin and the second resin are composed of a resin of an identical material; and the first resin contains a physical property changing filler that changes physical properties. According to this structure, it is possible to change the physical properties of the first resin such that the physical properties of the first resin become desirable. In this way, it is possible to achieve the good physical properties by means of the first resin while alleviating problems (crash, peeling, warp and the like that are caused by difference in adhesion properties (bond strengths), thermal expansion coefficients and rigidities of two kinds of resins) due to a combination of resins of different materials (polymer).

In the above light source board unit, preferably, the first resin and the second resin are composed of a resin of an identical material; and the second resin contains a reflectance improving filler that improves the total light reflectance. According to this structure, it is possible to achieve the good total light reflectance by means of the second resin while alleviating problems (crash, peeling, warp and the like that are caused by difference in adhesion properties (bond strengths), thermal expansion coefficients and rigidities of two kinds of resins) due to a combination of resins of different materials.

In the above light source board unit, preferably, the first resin and the second resin are composed of resins of materials different from each other; and at least part of a main surface of the base member and at least part of a rear surface of the base member are formed of the second resin portion. According to this structure, even in a case where the thermal expansion coefficient of the first resin portion and the thermal expansion coefficient of the second resin portion are different from each other, it is possible to alleviate the warp that occurs in the base member.

In the above light source board unit, preferably, the recess portion has a bottom surface on which the light emitting device is mounted and an inner side surface that is disposed along a side of the light emitting device; and at least parts of the bottom surface and the inner side surface are formed of the second resin portion. According to this structure, it is possible to make the optical properties of at least the parts of the bottom surface and the part of the inner surface of the recess portion different from the optical properties of the other parts.

In the above light source board unit, preferably, a seal resin layer is disposed in the recess portion; and the seal resin layer contains a fluorescent material that converts the light from the light emitting device into light of a different color. According to this structure, it is possible to protect the light emitting device by means of the seal resin layer while converting the light from the light emitting device into light of a desired color by means of the fluorescent material.

In the above light source board unit, preferably, the light emitting device is formed of a light emitting chip; the base member is provided with a wiring layer; the light emitting chip is mounted on the bottom surface of the recess portion or on the wiring layer by means of bare chip mounting and electrically connected to the wiring layer. According to this structure, unlike a case where a package incorporating the light emitting chip is mounted on the base member, it is possible to directly radiate heat generated by the light emitting device to the base member without passing through a package. In this way, it is possible to alleviate the properties of the light emitting device deteriorating and the life of the light emitting device becoming short.

In this case, preferably, the wiring layer is exposed to an inside of the recess portion; and a silver layer is disposed on a surface of at least part of the wiring layer in the recess portion. According to this structure, it is possible to reflect the light, which is output from the light source board unit and returned by reflection or the like, by means of the silver layer; accordingly, it is possible to improve the light use efficiency.

In the above light source board unit in which the wiring layer is disposed on the base member, preferably, the wiring layer is insert-molded or outsert-molded in the first resin portion; and the first resin portion is insert-molded or outsert-molded in the second resin portion. According to this structure, it is possible to easily form the base member in which the wiring layer, the first resin portion and the second resin portion are in tight contact with one another.

In the meantime, the insert molding means that an insert component (metal component, resin molded product and the like) is set in a metal mold; and by flowing a resin into it to integrally form the insert component and the resin portion with each other. The outsert molding means that an outsert component (metal component, resin molded product and the like) is set in a metal mold; and by flowing a resin into it to integrally form the outsert component and the resin portion with each other. The outsert molding is different from the insert molding in that in the outsert molding, a resin portion is formed on part (locally) of a metal component or a resin molded product.

In the above light source board unit, preferably, the first resin portion and the second resin portion are molded in separate processes; and the first resin portion and the second resin portion are integrally combined with each other to form the base member. According to this structure, it is possible to form each of the first resin portion and the second resin portion by means of an optimum method (resin material, cure temperature and the like).

In the above light source board unit in which the first resin portion and the second resin portion are formed in the separate processes, preferably, the first resin portion and the second resin portion are fitted into each other to form the base member. According to this structure, it is possible to achieve the base member in which the first resin portion and the second resin portion are formed integrally with each other without using an adhesive and the like.

In the above light source board unit in which the first resin portion and the second resin portion are formed in the separate processes, preferably, the first resin portion and the second resin portion are bonded to each other to form the base member. According to this structure, it is possible to easily form the base member in which the first resin portion and the second resin portion are formed integrally with each other.

In the above light source board unit, preferably, the first resin portion and the second resin portion are formed integrally with each other by means of multicolor molding. According to this structure, it is possible to easily form the base member in which the first resin portion and the second resin portion are formed integrally with each other. Besides, there is a possibility that the first resin portion and the second resin portion can be strongly joined to each other.

In the meantime, the multicolor molding is a molding method which uses two or more kinds of resins different from each other in color, material or hardness, in which an entirety or part of a primary molded product formed in an earlier stage is molded integrally with a secondary molded product formed of a different resin.

In the above light source board unit, preferably, the first resin portion and the second resin portion are integrally combined with each other by means of insert molding or outsert molding to form the base member. According to this structure, it is possible to easily form the base member in which the first resin portion and the second resin portion are in tight contact with each other.

In this case, preferably, the second resin is added to the injection-molded first resin portion, insert-molded or outsert-molded to form the base member. According to this structure, for example, even if the second resin portion does not have sufficient hardness as an inset component or an outsert component, it is possible to form the base member into a desired shape. In the meantime, in the case where the second resin portion does not have the sufficient hardness as an inset component or an outsert component, if the second resin portion is formed in an earlier stage; thereafter the first resin is added and molded, deformation and deviation occur in the second resin portion, so that it is impossible to form the base member into the desired shape.

In the above light source board unit, preferably, the first resin portion and the second resin portion are formed integrally with each other by means of mixed color molding. According to this structure, it is possible to easily form the base member in which the first resin portion and the second resin portion are formed integrally with each other. Besides, there is a possibility that the first resin portion and the second resin portion can be strongly joined to each other.

In the meantime, the mixed color molding is a forming method which uses two or more kinds of resins different from each other in color, material or hardness, in which a plurality of resins are successively or alternately injected, for example, to form integrally with each other.

In this case, preferably, the first resin portion and the second resin portion are formed integrally with each other by means of sandwich molding in which the first resin is used as a core resin and the second resin is used as a skin resin. According to this structure, it is possible to easily form a portion (e.g., the main surface of the base member) needing the good optical properties by means of the second resin portion.

In the meantime, the sandwich molding is a kind of mixed color molding that is a method, in which a skin resin for forming a skin layer (outer layer) is flown (injected) into a metal mold; a core resin for forming a core layer (inner layer) is flown (injected) into inside of the skin resin; and these resins are cured to obtain a product that has a multilayer structure.

### Advantageous Effects of Invention

As described above, according to the present invention, it is possible to easily obtain a light source board unit that is able to improve the degree of freedom of shape and material of a resin portion, alleviate the cost increasing, and allow the optical properties and the physical properties to be compatible with each other.

### BRIEF DESCRIPTION OF DRAWINGS

FIG. 1 is a plan view showing a structure of a light source board unit according to a first embodiment of the present invention.

FIG. 2 is a cross-sectional view showing the structure of the light source board unit according to the first embodiment of the present invention shown in FIG. 1.

FIG. 3 is an exploded perspective view schematically showing a structure of a display apparatus that includes the light source board unit according to the first embodiment of the present invention shown in FIG. 1.

FIG. 4 is a cross-sectional view schematically showing the structure of the display apparatus shown in FIG. 3.

FIG. 5 is a plan view showing a structure of a light source board unit according to a second embodiment of the present invention.

FIG. 6 is a cross-sectional view showing the structure of the light source board unit according to the second embodiment of the present invention shown in FIG. 5.

FIG. 7 is a plan view showing a structure of a light source board unit according to a third embodiment of the present invention.

FIG. 8 is a cross-sectional view showing the structure of the light source board unit according to the third embodiment of the present invention shown in FIG. 7.

FIG. 9 is an exploded perspective view schematically showing an example of a structure of a conventional backlight apparatus.

FIG. 10 is a cross-sectional view schematically showing the structure of the conventional backlight apparatus shown in FIG. 9.

FIG. 11 is a plan view showing a structure of a light source board unit of the conventional backlight apparatus shown in FIG. 9.

FIG. 12 is a cross-sectional view showing the structure of the light source board unit of the conventional backlight apparatus shown in FIG. 9.

### DESCRIPTION OF EMBODIMENTS

Hereinafter, embodiments of the present invention are described with reference to the drawings. In the meantime, for the sake of easy understanding, there is a case where hatching is not applied even to a cross-sectional view, and there is a case where hatching is applied to a view even if the view is not a cross-sectional view.

### First Embodiment

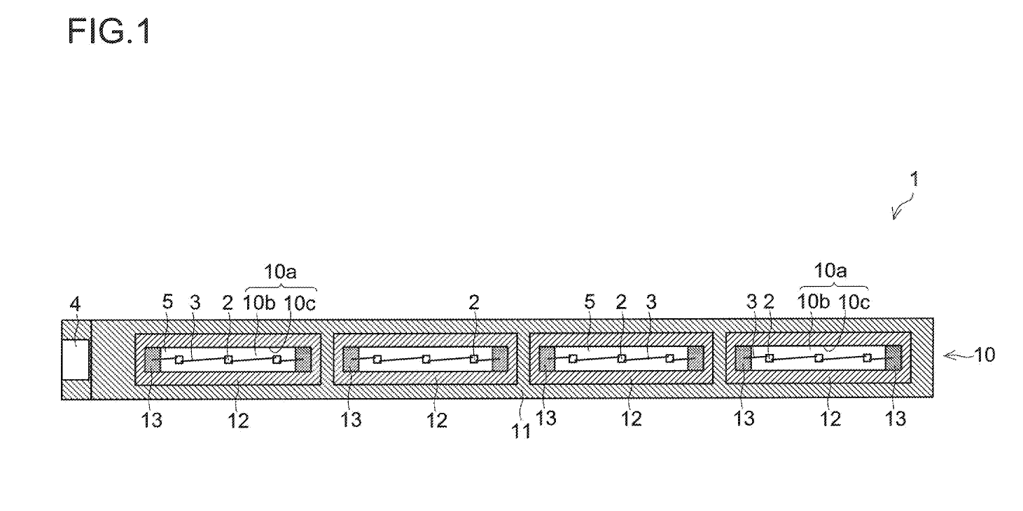

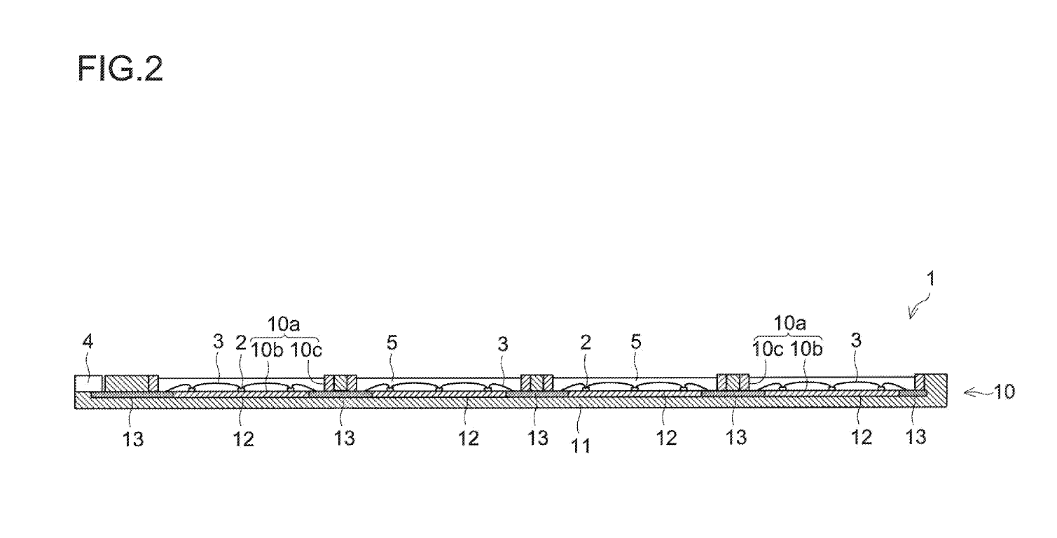

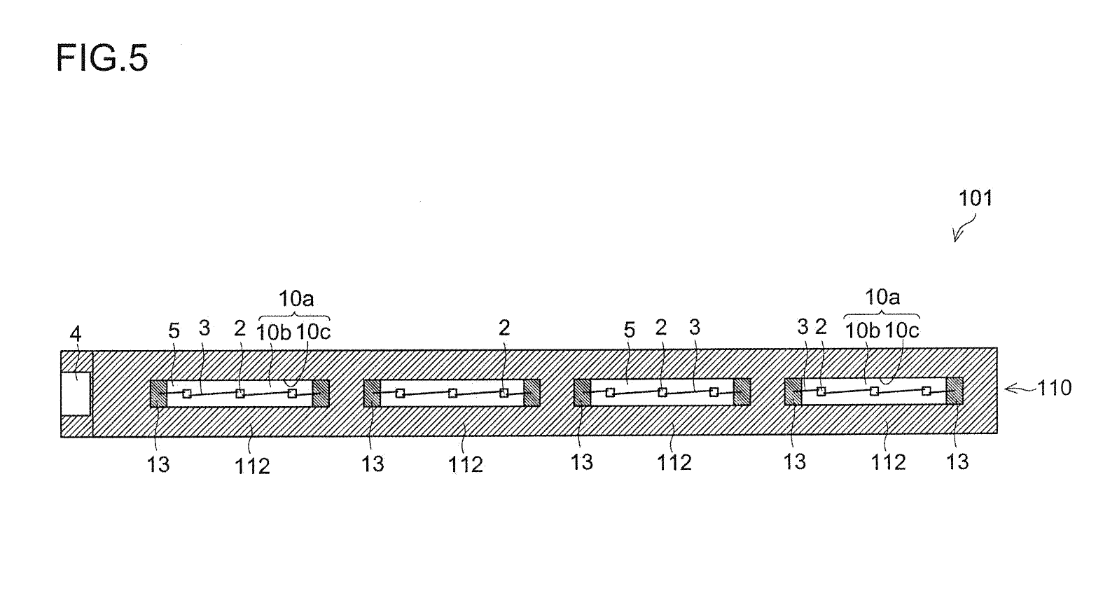

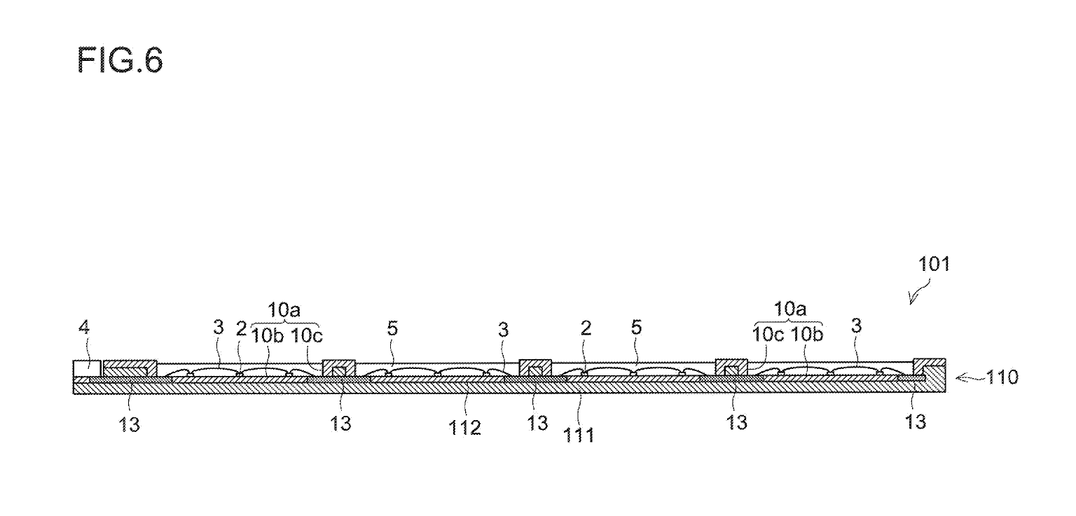

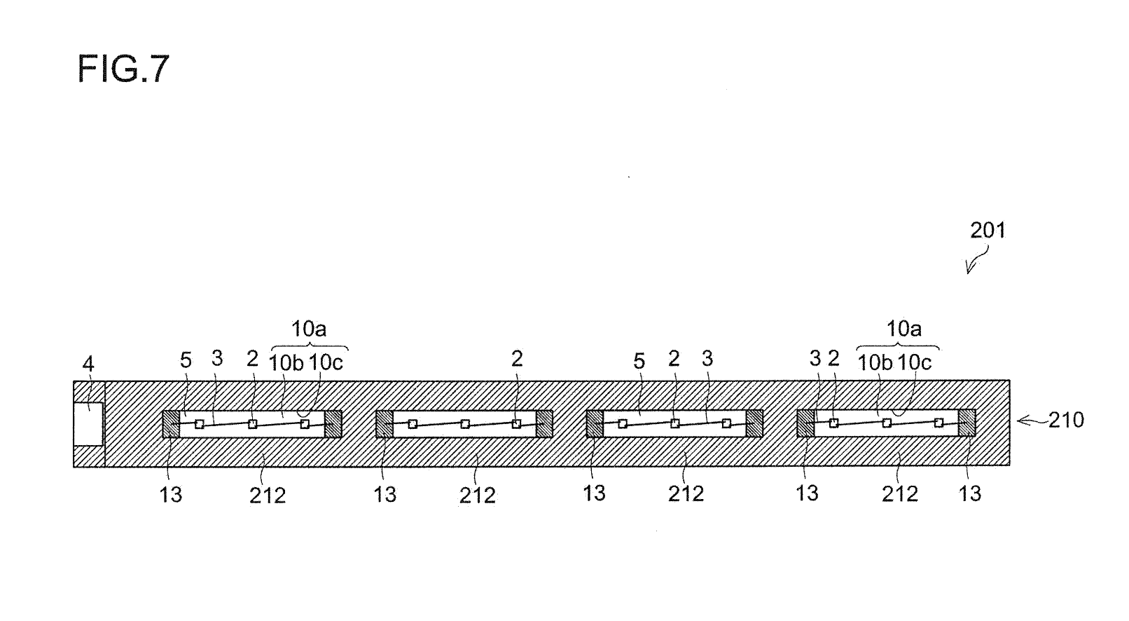

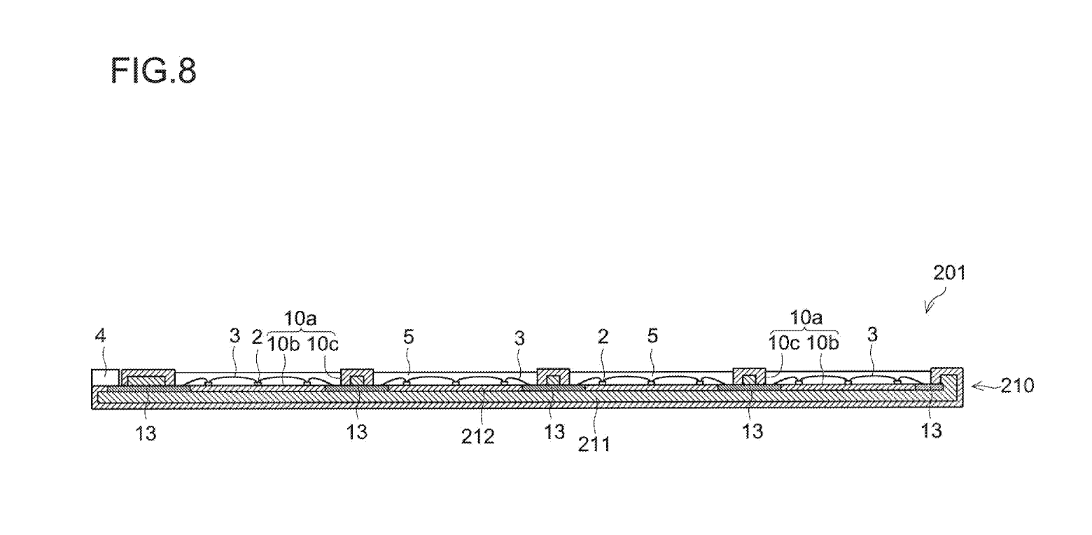

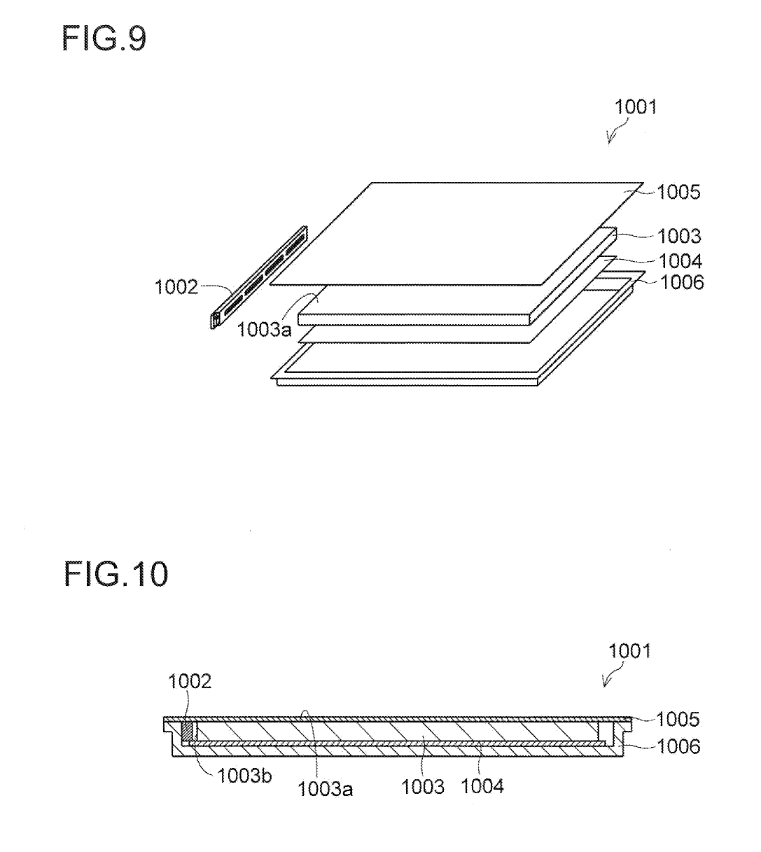

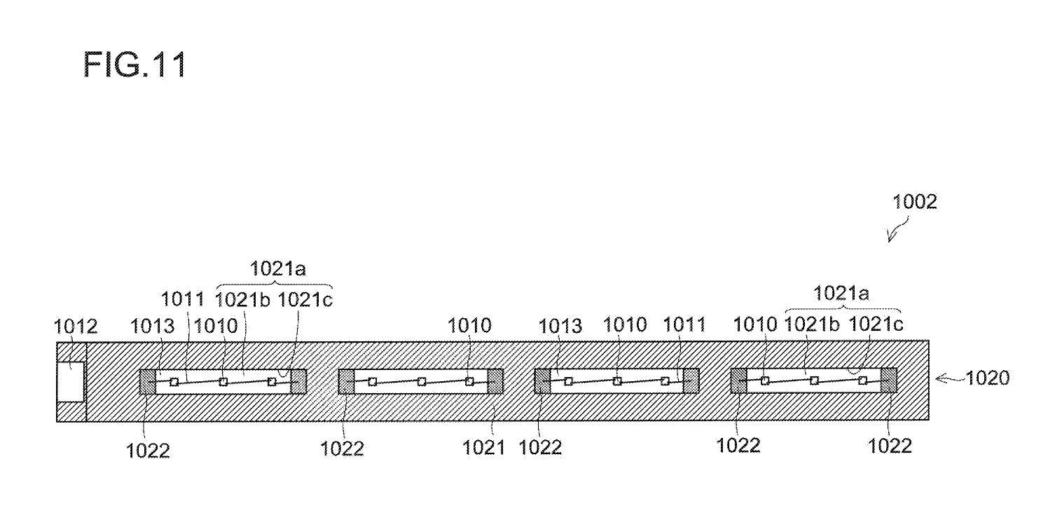

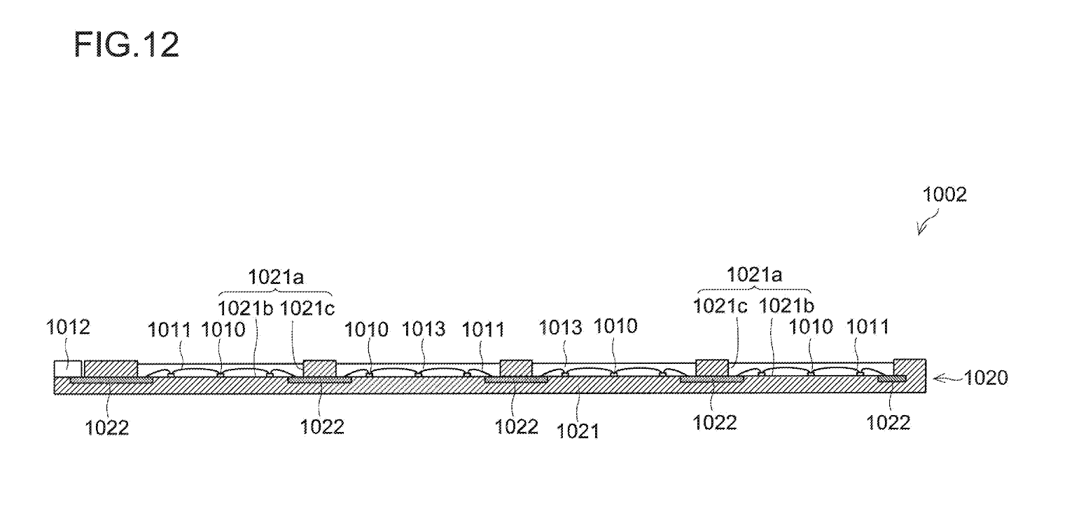

With reference to FIG. 1 to FIG. 4, a structure of a light source board unit 1 according to a first embodiment of the present invention is described. As shown in FIG. 1 and FIG. 2, the light source board unit 1 includes a plurality of LED chips 2, and a base member 10 in which the LED chip 2 (light emitting device, light emitting chip) is mounted. The base member 10 includes: a first resin portion 11 obtained by injection-molding a first resin; a second resin portion 12 obtained by injection-molding a second resin; and a wiring layer 13 formed of a metal. In the present embodiment, four second resin portions 12 are disposed for one first resin portion 11. The first resin portion 11, the second resin portion 12, and the wiring layer 13 are formed integrally with one another. In the meantime, in FIG. 1 and FIG. 2, for the sake of easy understanding of a structure of the base member 10, hatching is applied to the first resin portion 11, the second resin portion 12, and the wiring layer 13. However, hatching is not applied to a surface of the second resin portion 12 on which the LED chip 2 is mounted. This also applies to FIG. 5 and FIG. 6 (second embodiment), FIG. 7 and FIG. 8 (third embodiment).

Besides, the base member 10 is provided with a plurality of (e.g., four) recess portions 10a that house the plurality of LED chips 2. An inner surface of the recess portion 10a has: a bottom surface 10b that is a mounting surface on which the LED chip 2 is mounted; and an inner side surface 10c that is disposed along a side of the LED chip 2. In the meantime, it is possible to suitably change the number of recess portions 10a disposed in the base member 10: two or a larger number is enough. Besides, it is possible to suitably change the number of LED chips 2 housed in one recess portion 10a: one or a larger number is enough.

In the present embodiment, the inner surface (bottom surface 10b and inner side surface 10c) of the recess portion 10a is formed of the second resin portion 12. The second resin portion 12 is disposed on a main surface side (light output side) of the base member 10, but not disposed on a rear side (surface opposite to the main surface) of the base member 10.

The LED chip 2 is mounted on the bottom surface 10b of the recess portion 10a by means of bare chip mounting, and electrically connected to the adjacent LED chip 12 and the wiring layer 13 by means of a bonding wire 3. In the meantime, the wiring layer 13 may be extended to a center of the recess portion 10a to mount the LED chip 2 on the wiring layer 13. Part of the wiring layer 13 is exposed to inside of the recess portion 10a. A silver layer may be disposed on a surface of the wiring layer 13 in the recess portion 10a. In this way, it is possible to raise the total light reflectance of the recess portion 10a. An area of the wiring layer 13 becomes large in a structure where the LED chip 2 is mounted on the wiring layer 13, which is especially effective. Of the plurality of wiring layers 13 disposed in the base member 10, the leftmost wiring layer 13 in FIG. 1 and FIG. 2 is electrically connected to an electrode terminal (not shown) of a connector member 4. A wire harness (not shown) for supplying electric power to the LED chip 2 is connected to the connector member 4.

Besides, a seal resin layer 5 formed of a substantially transparent resin is disposed in the recess portion 10a, and the LED chip 2 and the bonding wire 3 are sealed by the seal resin layer 5.

The light source board unit 1 outputs white light. For example, the LED chip 2 may emit blue light, and the second resin portion 12 may contain a fluorescent material that converts the blue light into yellow light. In this case, the blue light from the LED chip 2 and the yellow light from the second resin portion 12 are mixed with each other, whereby the white light is obtained. Besides, for example, the seal resin layer 5 may contain a fluorescent material that converts the light from the LED chip 2 into light of a different color. In this case, the light from the LED chip 2 and the light from the seal resin layer 5 are mixed with each other, whereby the white light is obtained.

Here, the light emitted from the LED chip 2 travels in an output direction (upper side of FIG. 2) of the light source board unit 1. And, most light enters illumination targets (e.g., a light guide plate, a member to be illuminated and the like included in a module). At this time, partial light is reflected by a surface of the illumination target, and most of the reflected light is shined onto a portion (mainly, the inner surface of the recess portion 10a) of the base member 10. This light shined onto the base member 10 is not absorbed by the base member 10 but is reflected to be shined again onto the illumination target, whereby the use efficiency of the light emitted from the LED chip 2 improves. Because of this, it is preferable that the portion (especially, the inner surface of the recess portion 10a) used for the reflection has a high total light reflectance. Besides, to alleviate the light color tone being changed by the reflection at the base member 10, it is preferable that the portion (especially, the inner surface of the recess portion 10a) used for the reflection is white.

Accordingly, the second resin portion 12 has the total light reflectance (one of the optical properties) higher than the first resin portion 11 and is formed to have a whitish color. The second resin may contain a reflectance improving filler that improves the total light reflectance. For example, if a white filler formed of titanium oxide and the like is contained as the reflectance improving filler in resins such as PET (Polyethylene Terephthalate), PTFE (Polytetrafluoroethylene), LCP (Liquid Crystal Polymer) and the like, it is possible to easily raise the total light reflectance of the second resin portion 12.

Besides, the base member 10 needs to fix the wiring layer 13, the connector member 4 and the like, and needs to have sufficient physical properties. Because of this, a portion (first resin portion 11), where the optical properties are especially required, other than the portion around the recess portion 10a is formed of a resin which is more excellent in the physical properties than the second resin portion 12. The first resin may contain a physical property changing filler that changes the physical properties. For example, if talc powder or the like is contained as the physical property changing filler in the first resin, it is possible to easily raise rigidity of the first resin portion 11. Besides, for example, if a polyamide resin, a polyimide resin or the like is used as the first resin, it is possible to improve thermal stability of the first resin portion 11.

As described above, the first resin and the second resin may be composed of a resin of an identical material (polymer) or composed of resins of materials different from each other. For example, even if a resin of an identical material (polymer) is used as the first resin and the second resin, by changing presence, kind, and contained amount of the filler, it is possible to easily change the optical properties and physical properties of both. Such a structure is effective in a case where for example, the linear expansion coefficients (one of the physical properties) of both are desired to be approximated to each other or in a case where the adhesion properties between both are desired to be improved.

There are various methods for forming the first resin portion 11, the second resin portion 12 and the wiring layer 13 integrally with one another.

For example, the wiring layer 13 may be insert-molded or outsert-molded as an insert component or an outsert component in the first resin portion 11. And, the first resin portion 11 and the wiring layer 13 may be insert-molded or outsert-molded as insert components or outsert components in the second resin portion 12. In other words, the second resin may be added and molded by insert molding or outsert molding in the injection-molded first resin portion 11 to form the base member 10.

Besides, the first resin portion 11 and the second resin portion 12 may be molded in separate processes. In this case, the first resin portion 11 and the second resin portion 12 may be fitted into each other to form the base member 10, or the first resin portion 11 and the second resin portion 12 may be bonded to each other by means of an adhesive (not shown) to form the base member 10. Besides, the base member 10 may be formed by using both the fitting-in and the bonding.

Besides, the first resin portion 11 and the second resin portion 12 may be formed integrally with each other by means of multicolor molding. Besides, the first resin portion II and the second resin portion 12 may be formed integrally with each other by means of mixed color molding. In this case, for example, by injecting the first resin, thereafter, flowing the reflectance improving filler, it is also possible to partially form the second resin.

The above light source board unit 1 is usable for an illumination apparatus that composes a display apparatus, for example. Hereinafter, a structure of a display apparatus 50, which includes an illumination apparatus 60 that uses the light source board unit 1, is described.

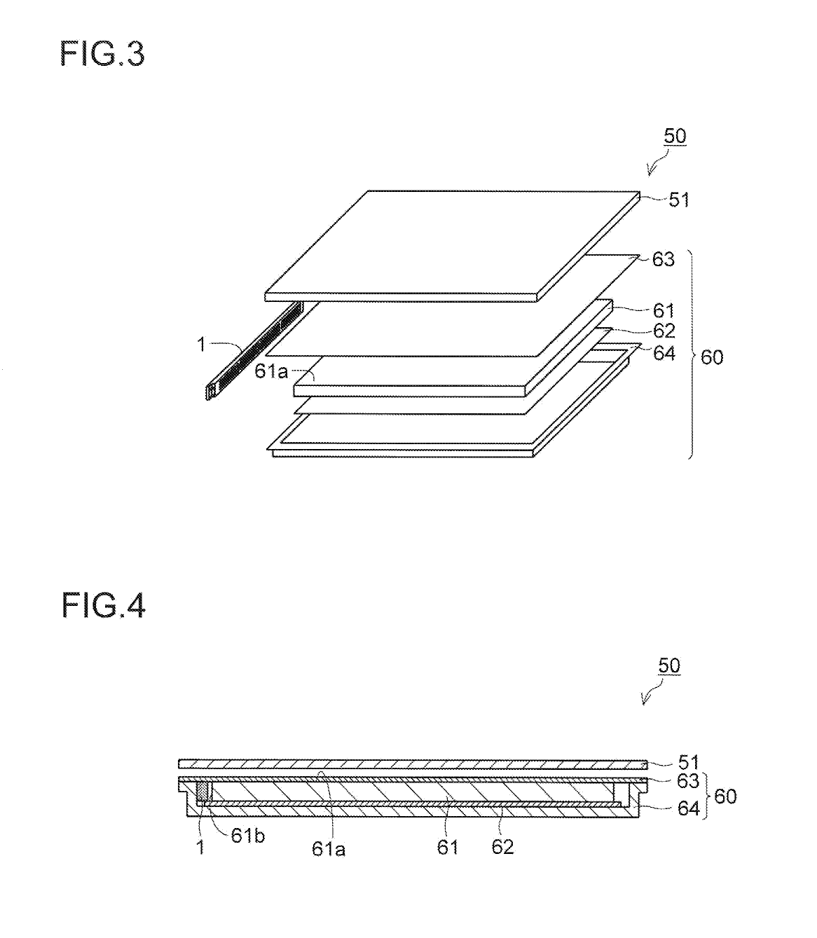

The display apparatus 50 is used, for example, for a television receiver and the like. As shown in FIG. 3 and FIG. 4, the display apparatus 50 comprises a display panel 51 and an illumination apparatus 60 that is disposed to oppose a rear side of the display panel 51 and illuminates the display panel 51.

The display panel 51 is formed of a liquid crystal display panel and has two glass boards that sandwich a liquid crystal layer (not shown). Besides, the display panel 51 displays an image by using light from the illumination apparatus 60.

The illumination apparatus 60 is a backlight apparatus of so-called edge light type. The backlight apparatus of edge light type disposes a light source at an edge portion of the backlight apparatus and outputs surface light by using a light guide plate and the like. The backlight apparatus of edge light type is advantageous to thickness reduction of an illumination apparatus compared with a backlight apparatus of so-called direct type that disposes a light source right under a rear surface of a member (display panel 51) to be illuminated.

The illumination apparatus 60 comprises: the above light source board unit 1; a light guide plate 61 into which the light from the light source board unit 1 is input and which outputs the light to the display panel 51 side; a reflection sheet 62 that is disposed on a rear side (lower side of FIG. 4) of the light guide plate 61; a diffusion sheet 63 that is disposed on the light guide plate 61; and a housing 64 that houses the light source board unit 1, the light guide plate 61 and the like.

The light guide plate 61 has: a light output surface 61a that is the largest surface and disposed under the display panel 51; and a light input surface 61b which is disposed to intersect the light output surface 61a and into which the light from the light source board unit 1 is input. The light output from the light source board unit 1 enters the light input surface 61b of the light guide plate 61. The light entering the light guide plate 61 is mixed in the light guide plate 61 to be evened and output as surface light from the light output surface 61a. The reflection sheet 62 has a function that reflects light, which leaks from the light guide plate 61 via a surface (lower surface of FIG. 4) opposite to the light output surface 61a, to return the light into the light guide plate 61. According to this, it is possible to improve the light use efficiency. The diffusion sheet 63 has a function that evens the light output from the light output surface 61a of the light guide plate 61 to alleviate the brightness unevenness.

In the present embodiment, as described above, the base member 10 includes the first resin portion 11 obtained by injection-molding the first resin and the second resin portion 12 obtained by injection-molding the second resin, and the first resin portion 11 and the second resin portion 12 have the optical properties different from each other. According to this, for example, as the first resin, it is possible to use a resin that has good physical properties, and as the second resin, it is possible to use a resin that has good optical properties. Because of this, it is possible to obtain the base member 10 that has both the good optical properties and the good physical properties. Or, even if the second resin has the good optical properties and the good physical properties, in a case where the second resin is expensive, it is possible to use the first resin for a portion where the optical properties are not important. In this way, it is possible to reduce a use amount of the second resin and alleviate the cost of the base member 10 becoming expensive.

Besides, as described above, by forming the inner surface of the recess portion 10a by means of the second resin portion 12, it is possible to make the optical properties of the inner surface of the recess portion 10a different from the optical properties of the other parts.

Besides, by forming the first resin portion 11 and the second resin portion 12 by means of injection molding, compared with a resin layer (resin portion) of a metal base board, for example, it is possible to improve the degree of freedom of shape and material (polymer) of the resin portion (the first resin portion 11 and the second resin portion 12).

Besides, as described above, the second resin portion 12 has the total light reflectance higher than the first resin portion 11. According to this, it is possible to raise the total light reflectance of the inner surface of the recess portion 10a; accordingly, it is possible to reflect the light, which is output from the light source board unit 1, reflected and returned by the surface of the illumination target (e.g., light guide plate 61), by means of the inner surface of the recess portion 10a with the high total light reflectance. Because of this, it is possible to improve the light use efficiency.

Besides, as described above, the second resin portion 12 has the whitish color. According to this, the color tone of the light reflected by the second resin portion 12 becomes unlikely to change. Besides, it is possible to easily raise the total light reflectance of the second resin portion 12.

Besides, as described above, the LED chip 2 may emit bluish light, the second resin portion 12 may contain a fluorescent material that converts the bluish light into yellowish light, and the bluish light from the LED chip 2 and the yellowish light from the second resin portion 12 may be mixed with each other to obtain the white light. In this case, it is possible to convert the bluish light into the yellowish light by means of the second resin portion 12; accordingly, it is unnecessary to additionally dispose a member that contains a fluorescent material which converts the bluish light into the yellowish light.

Besides, as described above, the first resin and the second resin may be composed of a resin of an identical material; and the first resin may contain a physical property changing filler that changes physical properties. In this case, it is possible to change the physical properties of the first resin such that the physical properties of the first resin become desirable. In this way, it is possible to achieve the good physical properties by means of the first resin while alleviating problems (crash, peeling, warp and the like that are caused by difference in adhesion properties (bond strengths), thermal expansion coefficients and rigidities of two kinds of resins) due to a combination of resins of different materials (polymer).

Besides, as described above, the first resin and the second resin may be composed of a resin of an identical material, and the second resin may contain a reflectance improving filler that improves the total light reflectance. In this case, it is possible to achieve the good total light reflectance by means of the second resin while alleviating problems (crash, peeling, warp and the like that are caused by difference in adhesion properties (bond strengths), thermal expansion coefficients and rigidities of two kinds of resins) due to a combination of resins of different materials.

Besides, as described above, the bottom surface 10b and inner side surface 10c of the recess portion 10a are formed of the second resin portion 12. The light, which is output from the light source board unit 1, reflected and returned by the surface of the illumination target (e.g., light guide plate 61), is liable to reach the bottom surface 10b and inner side surface 10c of the recess portion 10a. Because of this, by forming the bottom surface 10b and inner side surface 10c of the recess portion 10a by means of the second resin portion 12 that has the high total light reflectance, it is possible to further raise the light use efficiency.

Besides, as described above, the seal resin layer 5 is disposed in the recess portion 10a. The LED chip 2, the bonding wire 3 and the connection portions for these are sometimes broken by an impact. However, by disposing the seal resin layer 5, it is possible to alleviate the above breakage. Besides, by means of the seal resin layer 5, it is possible to protect the LED chip 2 and the bonding wire 3 from water and foreign mater. Besides, it is possible to alleviate the silver layer on the surface of the wiring layer 13 being oxidized. Further, as described above, the seal resin layer 5 may contain a fluorescent material that converts the light from the LED chip 2 into light of a different color. In this case, it is possible to convert the light from the LED chip 2 into light of a desired color by means of the fluorescent material of the seal resin layer 5; accordingly, it is unnecessary to additionally dispose a member that contains a fluorescent material which converts the light from the LED chip 2.

Besides, as described above, the LED chip 2 is mounted on the base member 10 by means of bare chip mounting. According to this, unlike a case where a package incorporating the LED chip 2 is mounted on the base member 10, it is possible to directly radiate heat generated by the LED chip 2 to the base member 10 without passing through a package. In this way, it is possible to alleviate the properties of the LED chip 2 deteriorating and the life of the LED chip 2 becoming short.

Besides, as described above, if a silver layer is disposed on the surface of the wiring layer 13 in the recess portion 10a, it is possible to further raise the total light reflectance of the recess portion 10a; accordingly, it is possible to further improve the light use efficiency.

Besides, as described above, the wiring layer 13 may be insert-molded or outsert-molded in the first resin portion 11, and the first resin portion 11 may be insert-molded or outsert-molded in the second resin portion 12. In this case, it is possible to easily form the base member 10 in which the wiring layer 13, the first resin portion 11 and the second resin portion 12 are in tight contact with one another.

Besides, as described above, the first resin portion 11 and the second resin portion 12 may be molded in separate processes, and the first resin portion 11 and the second resin portion 12 may be integrally combined with each other to form the base member 10. In this case, it is possible to form each of the first resin portion 11 and the second resin portion 12 by means of an optimum method (resin material, cure temperature and the like).

And, the first resin portion 11 and the second resin portion 12 may be fitted into each other to form the base member 10. In this case, it is possible to achieve the base member 10 in which the first resin portion 11 and the second resin portion 12 are formed integrally with each other without using an adhesive. Besides, the first resin portion 11 and the second resin portion 12 may be bonded to each other to form the base member 10. In this case, it is possible to easily form the base member 10 in which the first resin portion 11 and the second resin portion 12 are formed integrally with each other.

Besides, as described above, the first resin portion 11 and the second resin portion 12 may be formed integrally with each other by means of multicolor molding. In this case, it is possible to easily form the base member 10 in which the first resin portion 11 and the second resin portion 12 are formed integrally with each other. Besides, there is a possibility that the first resin portion 11 and the second resin portion 12 can be strongly joined to each other.

Besides, as described above, the second resin may be added to the insert-molded first resin portion 11, insert-molded or outsert-molded to form the base member 10. In this case, even if the second resin portion 12 does not have sufficient hardness as an inset component or an outsert component, it is possible to form the base member 10 into a desired shape. In the meantime, in the case where the second resin portion 12 does not have the sufficient hardness as an inset component or an outsert component, if the second resin portion 12 is formed in an earlier stage; thereafter the first resin is added and molded, deformation and deviation occur in the second resin portion 12, so that it is impossible to form the base member 10 into the desired shape. Besides, generally, there are many cases where in a white resin, reflectance declines and yellowing occurs because of heat; accordingly, it is more preferable that the first resin portion 11 is molded; thereafter the second resin portion 12 is molded than the white second resin portion 12 is formed in an earlier stage.

Besides, as described above, the first resin portion 11 and the second resin portion 12 may be formed integrally with each other by means of mixed color molding. In this case, it is possible to easily form the base member 10 in which the first resin portion 11 and the second resin portion 12 are formed integrally with each other. Besides, there is a possibility that the first resin portion 11 and the second resin portion 12 can be strongly joined to each other.

### Second Embodiment

As shown in FIG. 5 and FIG. 6, in a second embodiment of the present invention, a light source board unit 101 includes the plurality of LED chips 2, and a base member 110 in which the LED chip 2 is mounted. The base member 110 includes: a first resin portion 11 obtained by injection-molding a first resin; a second resin portion 112 obtained by injection-molding a second resin; and the wiring layer 13 formed of a metal. In the meantime, in FIG. 5 and FIG. 6, for the sake of easy understanding of a structure of the base member 110, hatching is applied to the first resin portion 111, the second resin portion 112, and the wiring layer 13.

In the present embodiment, the second resin portion 112 is formed by connecting the plurality of second resin portions 12 in the above first embodiment to one another. Besides, the first resin portion 111 is mainly disposed on a rear side of the base member 110, while the second resin portion 112 is mainly formed on a main surface side of the base member 110. And, apart from the wiring layer 13, an entirety of a surface opposing a light output side of the base member 110 is formed of the second resin portion 112. In this way, it is possible to further improve the light use efficiency.

In the meantime, the other structures of the second embodiment are the same as the above first embodiment.

Besides, the method for forming the first resin portion 111, the second resin portion 112 and the wiring layer 13 integrally with one another is the same as the above first embodiment.

For example, the first resin portion 111 and the second resin portion 112 may be formed by means of multicolor molding or mixed color molding. In the present embodiment, the first resin portion 111 and the second resin portion 112 are mainly formed on the rear side and the main surface side of the base member 10, respectively; accordingly, it becomes easy to mold them by using these molding methods. Besides, in the case of performing multicolor molding, the portion (second resin portion 112) formed of the second resin is integrally formed; accordingly, it is possible to inject the second resin from a common gate (injection opening of a metal mold).

Besides, in the case where the first resin portion 111 and the second resin portion 112 are molded in separate processes; thereafter both are formed integrally with each other, the portion (second resin portion 112) formed of the second resin is integrally formed; accordingly, the number of components mounted on the first resin portion 111 is small and it is possible to simplify the assembly process.

The other production methods and effects of the second embodiment are the same as the above first embodiment.

### Third Embodiment

As shown in FIG. 7 and FIG. 8, in a third embodiment of the present invention, a light source board unit 201 includes the plurality of LED chips 2, and a base member 210 in which the LED chip 2 is mounted. The base member 210 includes: a first resin portion 211 obtained by injection-molding a first resin; a second resin portion 212 obtained by injection-molding a second resin; and the wiring layer 13 formed of a metal. In the meantime, in FIG. 7 and FIG. 8, for the sake of easy understanding of a structure of the base member 210, hatching is applied to the first resin portion 211, the second resin portion 212, and the wiring layer 13.

In the present embodiment, the second resin portion 212 is disposed on not only the main surface side of the base member 210 but also the rear side. Besides, the first resin portion 211 is covered by the second resin portion 212 not to be exposed to outside. The base member 210 is formed integrally by means of sandwich molding (a kind of mixed color molding) in which the first resin is used as a core resin and the second resin is used as a skin resin.

In the meantime, the second resin portion 212 may be separated into the main surface side and rear side of the base member 210. In this case, it is possible to form the base member 210 by means of the same methods as the first embodiment and the second embodiment.

The other structures of the third embodiment are the same as the above second embodiment.

In the present embodiment, as described above, the main surface side and rear side of the base member 10 are formed of the second resin portion 12. According to this, even in a case where the first resin and the second resin are composed of resins of different materials and the thermal expansion coefficient of the first resin portion 11 and the thermal expansion coefficient of the second resin portion 12 are different from each other, it is possible to alleviate a warp occurring in the base member 10.

Besides, as described above, the first resin portion 11 and the second resin portion 12 may be formed integrally with each other by means of sandwich molding in which the first resin is used as a core resin and the second resin is used as a skin resin. In this case, it is possible to easily form the portion (the main surface side of the base member 10) needing the good optical properties by means of the second resin portion 12.

The other effects of the third embodiment are the same as the above second embodiment.

In the meantime, it should be considered that the embodiments disclosed this time are examples in all respects and are not limiting. The scope of the present invention is not indicated by the above description of the embodiments but by the claims, and all modifications within the scope of the claims and the meaning equivalent to the claims are covered.

For example, in the above embodiments, the example is described, in which the light source board unit is used in the backlight apparatus that illuminates the display panel. However, the present invention is not limited to this, but is also applicable to an illumination apparatus that illuminates a member to be illuminated other than the display panel. For example, the present invention is also applicable to a ceiling illumination apparatus that comprises a panel (member to be illuminated) and to an illumination apparatus that illuminates a display plate (member to be illuminated) of a signboard from a rear side.

Besides, in the above embodiments, the example is described, in which the light emitting device formed of the light emitting chip is mounted on the base member by means of bare chip mounting. However, the present invention is not limited to this. A light emitting device formed of a package incorporating the light emitting chip may be mounted on the base member.

Besides, in the above embodiments, the example is described, in which the LED chip is used as the light emitting chip. However, the present invention is not limited to this, but a light emitting chip other than the LED chip may be used.

Besides, in the above embodiments, the example is described, in which by using the LED chip which emits the blue light and the fluorescent material which converts the blue light into the yellow light, the white light is obtained. However, the present invention is not limited to this. By using three kinds of light emitting chips which emit red light, green light and blue light, respectively, the white light may be obtained. Besides, by using an LED chip which emits ultraviolet light and three kinds of fluorescent materials which convert the ultraviolet light into the red light, the green light and the blue light, respectively, the white light may be obtained.

Besides, in the above embodiments, the example is described, in which the light source board unit is structured to output the white light. However, the present invention is not limited to this, but the light source board unit may be structured to output light other than the white light.

Besides, for example, in the above second embodiment, the example is described, in which the main surface side of the base member is formed of the second resin portion and the rear side of the base member is formed of the first resin portion. However, the present invention is not limited to this. The main surface side of the base member be formed of the first resin portion and the second resin portion. Likewise, the rear side of the base member may be formed of the first resin portion and the second resin portion. The amount (area and thickness) of the second resin portion of the main surface side of the base member and the amount (area and thickness) of the second resin portion of the rear side of the base member may be suitably set such that the warp of the base member becomes smaller.

Besides, in the above embodiments, the example is described, in which in the case where the materials (polymer) of the first resin and second resin are identical to each other, the presence, kind, and contained amount of the filler are changed. However, the present invention is not limited to this. The materials of the first resin and second resin may be identical to each other, and the presence, kind, and contained amount of the filler may be the same. In this case, for example, by making the curing conditions of the first resin and second resin different from each other and by adding or changing a pre-process and a post-process, the first resin portion and second resin portion after the molding may have properties (optical properties and physical properties) different from each other.

Besides, in the above embodiments, the example is described, in which the total light reflectance of the second resin portion is higher than the total light reflectance of the first resin portion. However, the present invention is not limited to this. The optical properties necessary are different depending on the use forms of the light source board unit; accordingly, the optical properties other than the total light reflectance of the second resin portion may be different from the optical properties other than the total light reflectance of the first resin portion. For example, a resin, which has a high reflectance for light (e.g., light output from the light source board unit) of a specific wavelength, may be used for the second resin porion. Also in this case, it is possible to improve the light use efficiency. Besides, for example, a resin, which has wide light distribution characteristics of diffuse reflection, may be used for the second resin portion. In this case, it is possible to efficiently diffuse and reflect the light that is reflected and returned by the illumination target.

### REFERENCE SIGNS LIST

1, 101, 201 light source board units
2 LED chip (light emitting device, light emitting chip)
5 seal resin layer
10, 110, 210 base members
10a recess portion
10b bottom surface
10c inner side surface
11, 111, 211 first resin portions
12, 112, 212 second resin portions
13 wiring layer

1. A light source board unit comprising:
a plurality of light emitting devices, and
a base member that has a plurality of recess portions in which the light emitting devices are mounted, wherein
the base member includes a first resin portion obtained by injection-molding a first resin and a second resin portion obtained by injection-molding a second resin,
the first resin portion and the second resin portion have optical properties different from each other, and
at least part of an inner surface of the recess portion is formed of the second resin portion.

2. The light source board unit according to claim 1, wherein
the second resin portion has total light reflectance higher than the first resin portion.

3. The light source board unit according to claim 1, wherein
the second resin portion has a whitish color.

4. The light source board unit according to claim 1, wherein
the light emitting device emits bluish light,
the second resin portion contains a fluorescent material that converts the bluish light into yellowish light, and
the bluish light from the light emitting device and the yellowish light from the second resin portion are mixed with each other to obtain the whitish light.

5. The light source board unit according to claim 1, wherein
the first resin and the second resin are composed of a resin of an identical material, and
the first resin contains a physical property changing filler that changes a physical property.

6. The light source board unit according to claim 1, wherein
the first resin and the second resin are composed of a resin of an identical material, and
the second resin contains a reflectance improving filler that improves the total light reflectance.

7. The light source board unit according to claim 1, wherein
the first resin and the second resin are composed of resins of materials different from each other, and
at least part of a main surface of the base member and at least part of a rear surface of the base member are formed of the second resin portion.

8. The light source board unit according to claim 1, wherein
the recess portion has a bottom surface on which the light emitting device is mounted and an inner side surface that is disposed along a side of the light emitting device, and
at least parts of the bottom surface and the inner side surface are formed of the second resin portion.

9. The light source board unit according to claim 1, wherein
a seal resin layer is disposed in the recess portion, and
the seal resin layer contains a fluorescent material that converts the light from the light emitting device into light of a different color.

10. The light source board unit according to claim 1, wherein
the light emitting device is formed of a light emitting chip,
the base member is provided with a wiring layer, and
the light emitting chip is mounted on the bottom surface of the recess portion or on the wiring layer by means of bare chip mounting, and electrically connected to the wiring layer.

11. The light source board unit according to claim 10, wherein
the wiring layer is exposed to an inside of the recess portion, and
a silver layer is disposed on a surface of at least part of the wiring layer in the recess portion.

12. The light source board unit according to claim 10, wherein
the wiring layer is insert-molded or outsert-molded in the first resin portion, and
the first resin portion is insert-molded or outsert-molded in the second resin portion.

13. The light source board unit according to claim 1, wherein
the first resin portion and the second resin portion are molded in separate processes, and
the first resin portion and the second resin portion are integrally combined with each other to form the base member.

14. The light source board unit according to claim 13, wherein
the first resin portion and the second resin portion are fitted into each other to form the base member.

15. The light source board unit according to claim 13, wherein
the first resin portion and the second resin portion are bonded to each other to form the base member.

16. The light source board unit according to claim 1, wherein
the first resin portion and the second resin portion are formed integrally with each other by means of multicolor molding.

17. The light source board unit according to claim 1, wherein
the first resin portion and the second resin portion are integrally combined with each other by means of insert molding or outsert molding to form the base member.

18. The light source board unit according to claim to 17, wherein
the second resin is added to the injection-molded first resin portion, insert-molded or outsert-molded to form the base member.

19. The light source board unit according to claim 1, wherein
the first resin portion and the second resin portion are formed integrally with each other by means of mixed color molding.

20. The light source board unit according to claim to 19, wherein
the first resin portion and the second resin portion are formed integrally with each other by means of sandwich molding in which the first resin is used as a core resin and the second resin is used as a skin resin.
